(19) United States
(12) Patent Application Publication
(10) Pub. No.: US 2005/0078837 A1
(43) Pub. Date: Apr. 14, 2005

(54) Wireless speaker system for use with ceiling fans

(76) Inventor: Charles Hornback, University Park, FL (US)

Correspondence Address: Alisha L. Huls, Suite 1600, 101 S. Hanley Road, St. Louis, MO, 63105, US

(21) Appl. No.: 10/928,695

(22) Filed: Aug. 26, 2004

Related U.S. Application Data
(60) Provisional application No. 60/510,745, filed on Oct. 11, 2003.

(51) Int. Cl. H04B 5/00; H04R 1/02

(52) U.S. Cl. 381/79; 381/124; 381/87; 381/386

(57) ABSTRACT

A multi-channel wireless speaker system to be used with ceiling fans wherein the audio source generator can be one of many medias, not limited by the following: television, stereophonic, monophonic, video game, home theater, public address system or security system. The audio source generator sends an audio signal to the transmitter that in turn relays the audio signal to the wireless receiver located in the ceiling fan housing member. The ceiling fan housing member includes speakers and a light source if desired. The speakers produce an omni directional sound due to their unique positioning within the ceiling fan. The wireless speaker system is powered by the existing voltage available to the ceiling fan, so no new wiring is required to install the speaker system. The speaker settings are manipulated via a remote control.

This application claims benefit of Provisional application Ser. No. 60/510,745 filed Oct. 9, 2003.

### BACKGROUND OF THE INVENTION

1. Field of Invention

This invention relates to a wireless speaker system configured for use with ceiling fans. The invention facilitates the ability to listen or play centrally located sound without the need for a stand or table.

2. Description of Prior Art

Generally, audio speaker systems are maintained within their own physical housing, although, in recent years the popularity of placing speakers within other household structures and electronics has risen. It has not been the practice to incorporate a wireless speaker system within a ceiling fan. The purpose of such a combination is to combine the functions of cooling and audio systems in one decorative, space saving location. 900 MHz wireless transmission has enabled audio wireless systems to be used in conjunction with many household fixtures.

Ceiling fans were developed in the nineteenth century to enhance ventilation in the factories of the Industrial Revolution. The combination of an electric chandelier with a ceiling fan became popular by the late 1920s.

No prior attempt is known to have been made to combine the wireless speaker system and the ceiling fan. The prior art represents combinations of audio and other structures as disclosed in the following U.S. Patents.

The patent to Weber, U.S. Pat. No. 4,528,620, discloses an audio chandelier that has an illuminating and audio system. The composite illumination and audio system comprises a mechanical structure that includes an illuminating system, an audio system, a resonant cavity, an electrical power supply circuit and a chimney for air flow ventilation.

The patent to Christie, U.S. Pat. No. 5,980,057, discloses a light-speaker assembly for connection with a conventional electrical light socket. This patent also discloses a housing containing a speaker, a receiver and an amplifier that connects to a conventional electrical light socket. The housing also comprises a socket for a conventional light source.

The patent to Geiger, U.S. Pat. No. 6,215,885, discloses a ventilation register that incorporates an audio system. The patent discloses an audio speaker arrangement comprising an audio speaker, a ventilation register, a front trim plate and a back plate.

### SUMMARY OF THE INVENTION

The wireless speaker system of the present invention is constructed in a manner wherein a ceiling fan housing member can support the speakers and receiver of said speaker system. The purpose of such a combination is to centralize audio entertainment within a common household fixture, in this case a ceiling fan. The integrated wireless speaker system/ceiling fan also provides a space saving mechanism by removing the need for speaker stands or tables. The wireless speaker system for ceiling fans includes an audio source generator, a transmitter, a receiver, an amplifier, speakers and a ceiling fan. An important feature of the invention is that the speakers may be controlled via a remote control. Another additional feature of the invention is that the power provided to the bottom of the ceiling fan also powers the wireless speaker system so that no new wiring is required to install the speaker system into an existing ceiling fan.

### BRIEF DESCRIPTION OF THE DRAWINGS

FIG. 1 is a generalized view of the wireless speaker system components and how they are connected.

FIG. 2 is a frontal view of the ceiling fan housing member and all of its components.

FIG. 3 is a cross-section view of the ceiling fan housing member.

FIG. 4 is a frontal, side and top view of the transmitter.

FIG. 5 is an enlarged view of the remote control components.

### DETAILED DESCRIPTION OF THE PREFERRED EMBODIMENTS

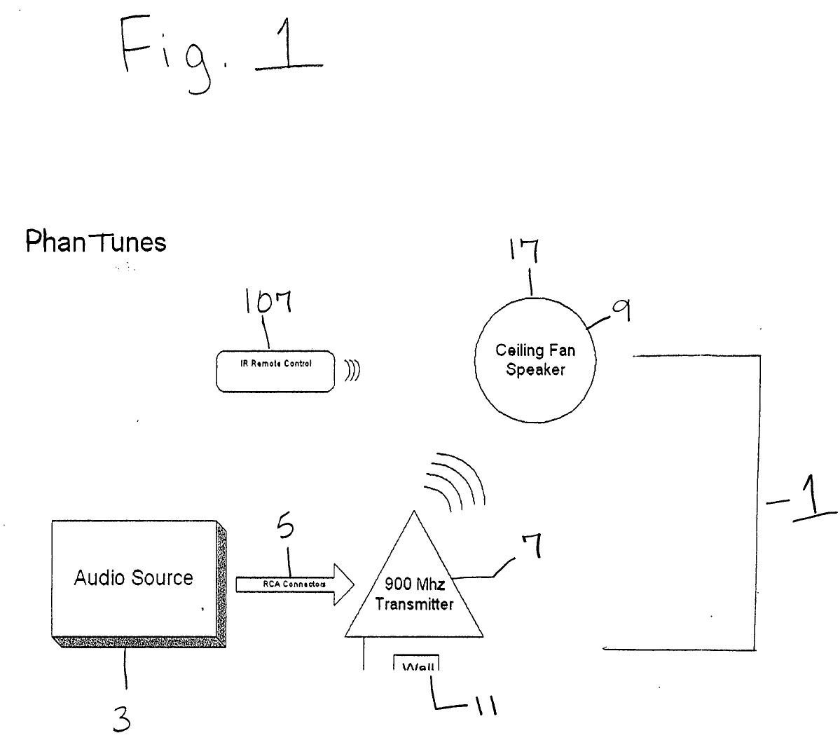

As shown in the accompanying figures, the present invention relates to a wireless speaker system used in combination with a ceiling fan, generally indicated as 1. Referring to FIG. 1, the wireless speaker system 1 includes an audio source generator 3, RCA (The Radio Corporation of America) connectors 5, an audio input cord 99 (not shown in FIG. 1), a transmitter 7, speakers 17, a wireless receiver 9 and a remote control 107. “RCA” is a registered trademark of General Electric Company.

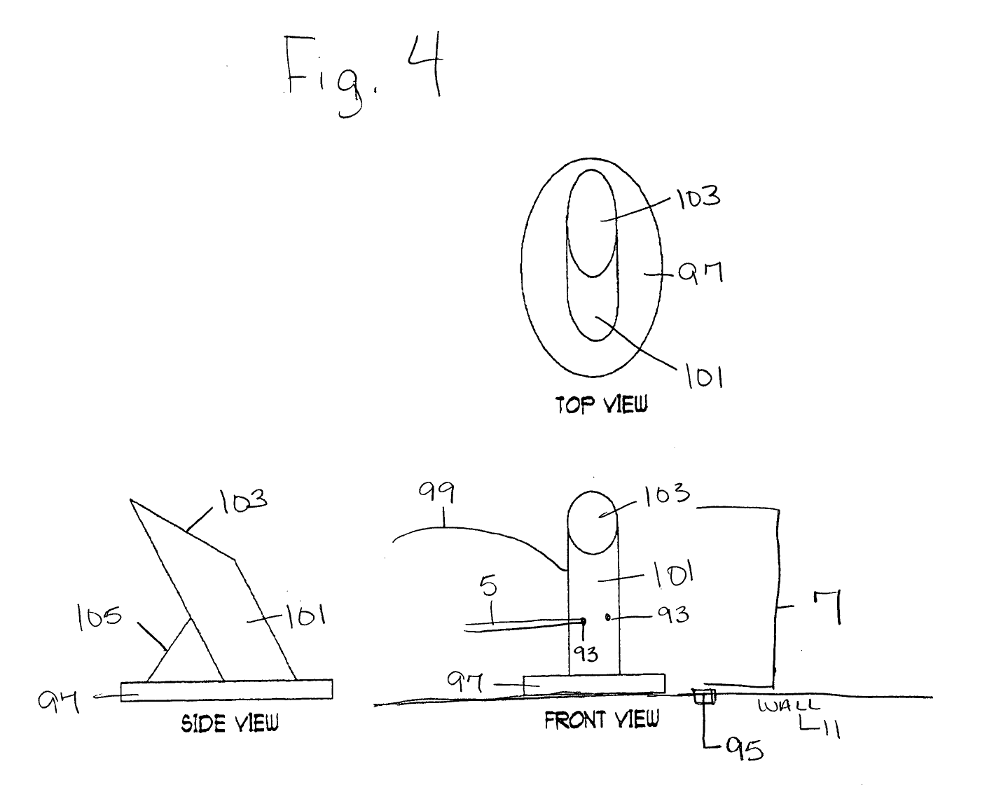

FIG. 4 shows the transmitter 7 in detail. The transmitter 7 has a base 97, a stand 101 with a support block 105 and a top surface 103. The transmitter 7 has two inputs 93 for audio source generators 3 and a wall transformer power source 95. As shown in FIG. 1, RCA connectors 5 connect the audio source generator 3 and the transmitter 7. An audio input cord 99 also runs to the transmitter 7. In one embodiment, the transmitter 7 is located in the wall 11.

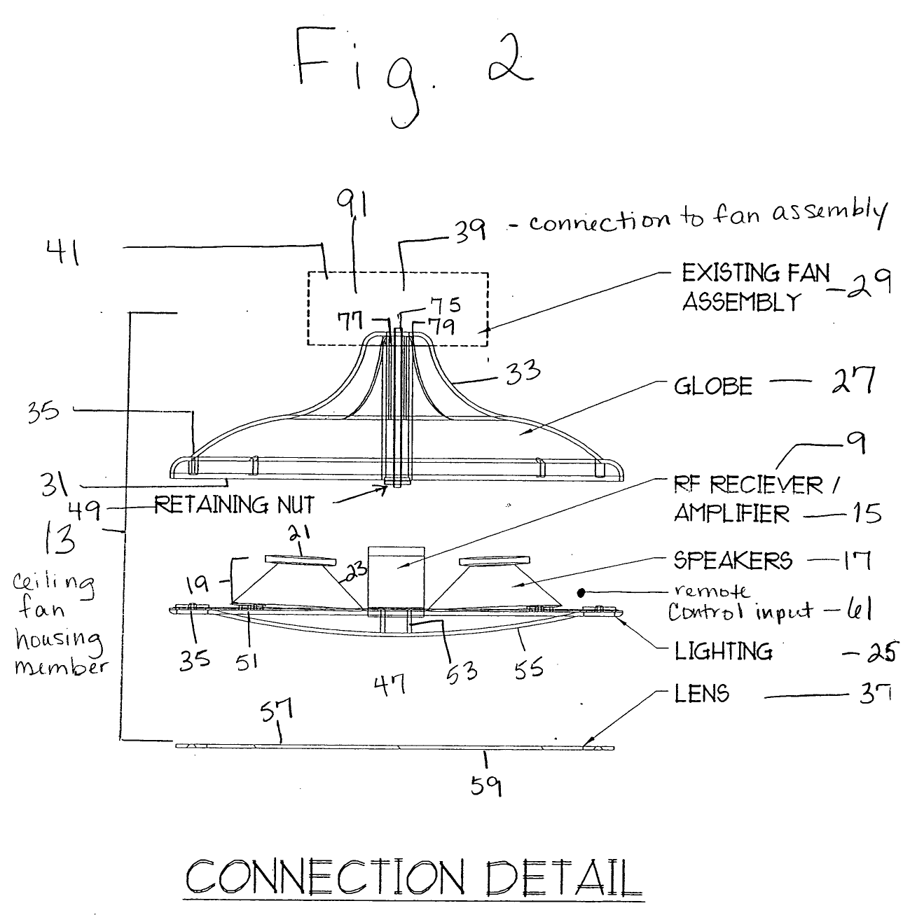

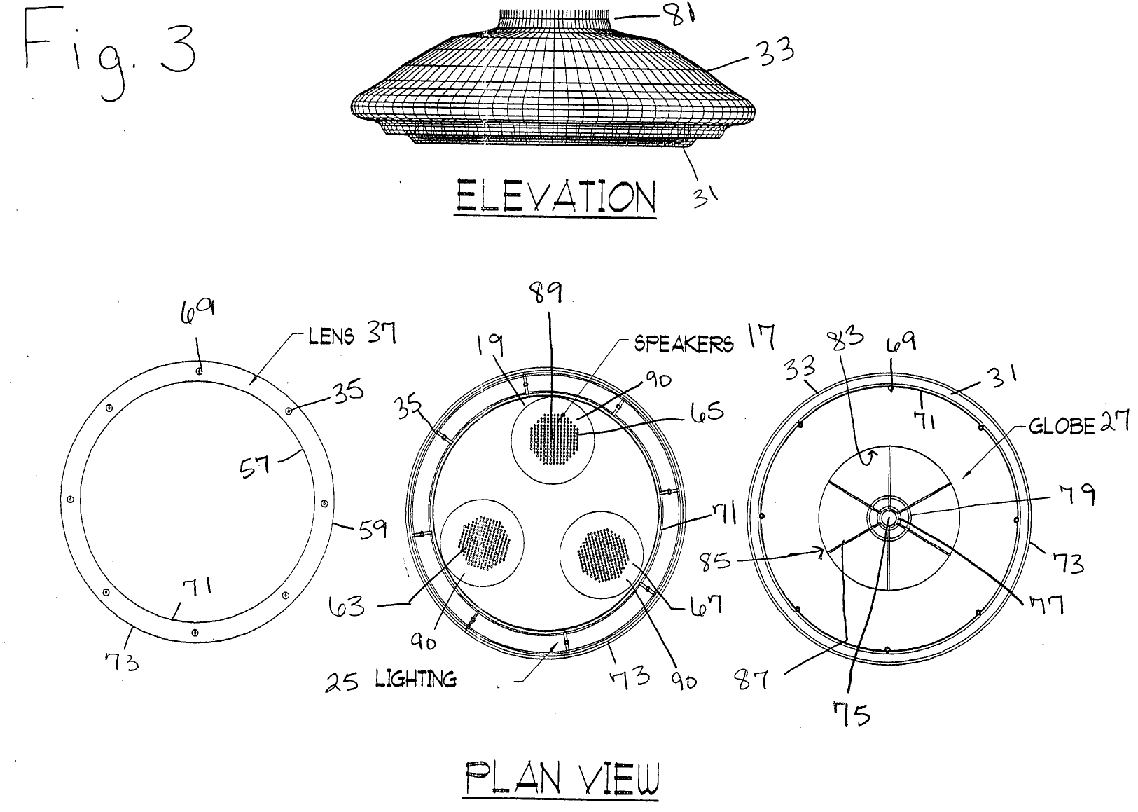

As illustrated in FIG. 2, the wireless receiver 9 is located in the ceiling fan housing member 13. The audio source generator 3 and the transmitter 7 are located distal from the wireless receiver 9. The amplifier 15 and the speakers 17, are also located in the ceiling fan housing member 13. The speakers 17 are enclosed by a speaker housing member 19 that consists of an upper surface 21 and a lateral surface 23. Reference is now made to FIG. 3. The speakers 17, in a preferred embodiment, consist of a bass speaker 63, a mid-range speaker 65 and a tweeter 67. Each speaker 17 has a sound grid 89 located on the outer surface 90 of the speakers 17. In a preferred embodiment, the speakers 17 are nine inches in diameter, but may virtually be any size in diameter. In yet another embodiment, the speakers 17 range from between 2-32 ohms. In a preferred embodiment, the speakers 17 may range from 2-16 ohms.

Referring now to FIG. 2, the upper portion of the ceiling fan housing member 13, the globe 27, attaches directly to the existing fan assembly 29 through an aperture 75 in the globe 27. Two supporting rings, an inner ring 77 and an outer ring 79 reinforce the aperture 75. The globe 27 includes a bottom rim 31 and an outer surface 33. The connection 39 of the fan housing member 13 to the existing fan assembly 29 is shown in dotted lines on FIG. 2. The existing fan assembly 29 also contains a fan assembly motor 41.

As shown in FIG. 3, the bottom rim 31 of the globe 27 has an interior rim 71 and an exterior rim 73. The globe 27 also has an upper ring 81 that connects to the existing fan assembly 29. The upper ring 81 has an interior surface 83 and an outer surface 85. Spokes 87 are attached to the interior surface 83 of the upper ring 81 to provide support to the globe 27. Also housed within the globe 27 is the drive shaft 43. A drive shaft chamber 45 surrounds the drive shaft 43. Along the bottom rim 31 of the globe are fasteners 35 that connect the globe 27 to the lighting source 25 and the lens 37. The fasteners 35 connect the components by fastener openings 69.

Referring back to FIG. 2, the lower portion of the ceiling fan housing member 13, the lens 37, contains the speakers 17, wireless receiver 9 and amplifier 15 within an enclosed space 47. The lens 37 is connected to the globe 27 via a retaining nut 49. The speakers 17 are connected to the lighting source 25 via screws 51 and the receiver 9 and amplifier 15 are connected to the lighting source 25 via connectors 53. The light source 25 includes an illuminating bulb 55. The lens 37 has an inner surface 57 and an outer surface 59. The fan housing member 13 also contains a remote control input 61 (not shown).

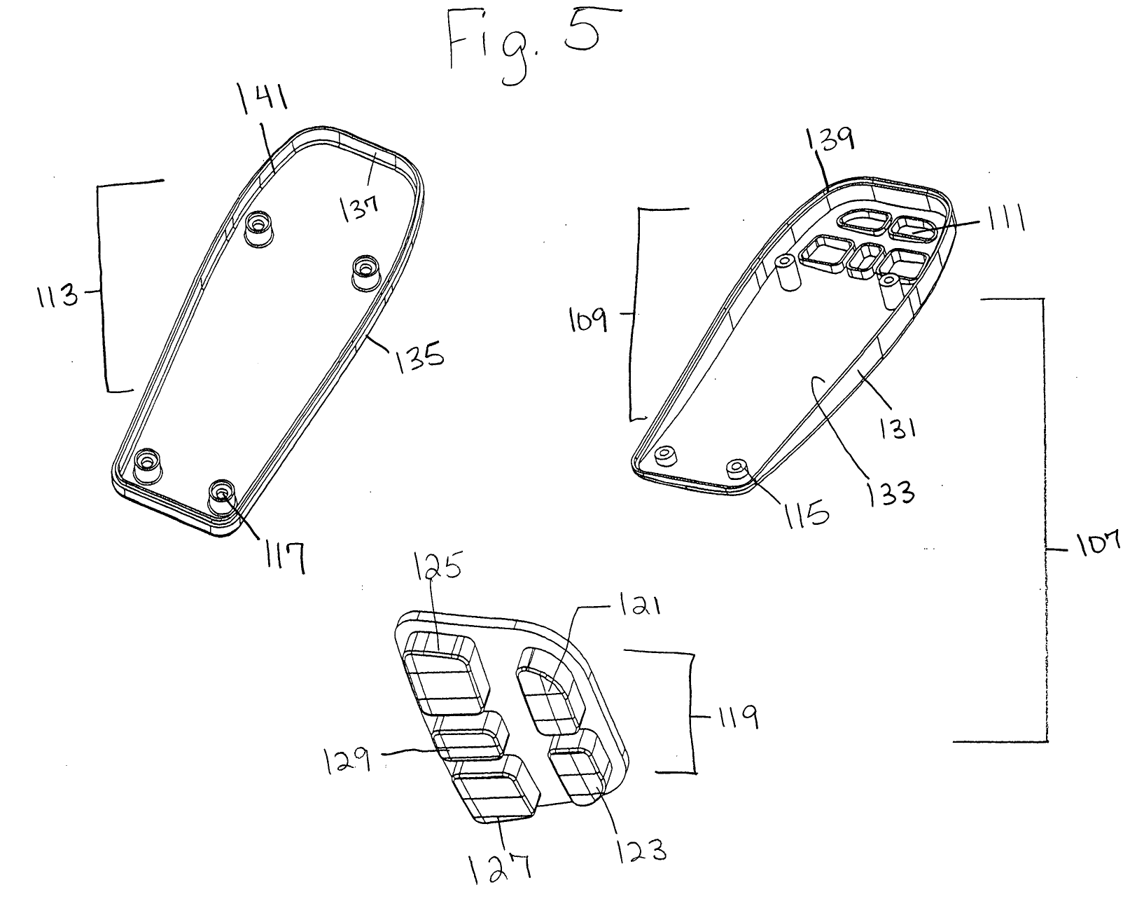

FIG. 5 shows a remote control 107. The wireless speaker system 1 can be operated via a remote control 107. The remote control 107 consists of a remote control top 109 with key pad openings 111 and a remote control bottom 113. The remote control top 111 and the remote control bottom 113 are connected with fasteners 115 via the fastener apertures 117. The remote control top 109 has an outer surface 131 and an inner surface 133. The remote control bottom 113 also has an outer surface 135 and an inner surface 137. When the remote control top 109 and the remote control bottom 113 are attached via the fasteners 115 the top surface of the remote control top 139 and the top surface of the remote control bottom 141 meet so that there is no opening between the two. The key pad 119 is placed between the remote control top 109 and the remote control bottom 111. In a preferred embodiment, the remote control key pad 119 has five speaker control buttons: the speaker system on/off button 121, the light source on/off button 123, volume up 125, volume down 127 and the receiver channel 129.

In one embodiment, the wireless speaker system 1 is simply installed in an existing ceiling fan. As shown in FIG. 2, the existing ceiling fan may contain a light source 25. In another embodiment, the wireless speaker system 1 is installed in a new ceiling fan. Also illustrated in FIG. 2, the wireless speaker system 1 may contain a light source 25 within the ceiling fan housing member 13. In another preferred embodiment, the light source 25 is white LED lighting due to its lack of heat radiation on the speakers 17.

In operation, the audio source generator 3 produces an audio signal that is imputed via the RCA connectors 5 and an audio input cord to the transmitter 7. The audio signal can be produced by a number of various audio source generators 3. In one embodiment, the wireless speaker system 1 is multi-channel, meaning that the audio is selectable from more than one source. The audio source generator 3 can be any audio source provider, not to be limited by the following: television; stereophonic; amplifier; monophonic; video game; home theater; public address system; or a public address system.

The transmitter 7 (FIG. 1) modulates the audio signal to a radio frequency and then transmits the audio signal wirelessly to a wireless receiver located in the ceiling fan housing member 13 (FIG. 2). The wireless receiver then demodulates the audio signal. Then, as depicted in FIG. 2, the amplifier 15 amplifies the audio sound portion of the audio signal. The amplified sound portion is then sent to the speakers 17. The audio waves then travel through the sound grids 89 (FIG. 3) of each speaker 17 out to the listening audience.

The wireless speaker system 1 is powered by the existing voltage available at the bottom of the ceiling fan also known as the input power 91 (FIG. 2). The transformer 95 (FIG. 4) converts the input power 91, 110 VAC, to a lower DC voltage. The DC voltage powers both the receiver 9 and the amplifier 15 (FIG. 2), which in turn powers the speakers 17. In a preferred embodiment, the DC voltage is 12 VDC or 15 VDC. In another embodiment, the DC voltage could be multiple voltages.

The remote control 107 (FIG. 5) is able to turn the speaker system 1 on or off, the lights on or off, the volume of sound being produced from the speakers 17 up or down and change to channel of the receiver 9 (FIG. 2) to overcome any interference. In a preferred embodiment the remote control 107 is infrared.

It should be understood that the aforementioned embodiments are for exemplary purposes only and are merely illustrative of the many possible specific embodiments that can represent applications of the principles of the invention.

1. A wireless speaker system for use with ceiling fans, comprising, a ceiling fan including a ceiling fan housing member;
said ceiling fan housing member containing a wireless receiver and speakers;
an audio source generator for generating audio signals, distal from said ceiling fan housing member;
a transmitter for transmitting said audio signals to said wireless receiver; and
an amplifier.

2. The wireless speaker system as in claim 1, wherein said system is multi-channel.

3. The wireless speaker system as in claim 1, wherein said system utilizes the existing power source already provided to said ceiling fan.

4. The wireless speaker system as in claim 1, wherein said ceiling fan housing member includes a power converter.

5. The wireless speaker system as in claim 1, wherein said ceiling fan housing member includes a remote control input.

6. The wireless speaker system as in claim 5, wherein said remote control input is infrared.

7. The wireless speaker system as in claim 5, wherein said remote control input is operated by a remote control system.

8. The wireless speaker system as in claim 7, wherein said remote control system controls speaker system on/off, audio volume up/down, receiver channel and light on/off.

9. The wireless speaker system as in claim 1, wherein said ceiling fan housing member includes speakers.

10. The wireless speaker system as in claim 9, wherein said speakers include a bass speaker.

11. The wireless speaker system as in claim 9, wherein said speakers include a tweeter speaker.

12. The wireless speaker system as in claim 9, wherein said speakers include a mid-range speaker.

13. The wireless speaker system as in claim 1, wherein said audio source generator is a television.

14. The wireless speaker system as in claim 1, wherein said audio source generator is stereophonic.

15. The wireless speaker system as in claim 1, wherein said audio source generator is an amplifier.

16. The wireless speaker system as in claim 1, wherein said audio source generator is monophonic.

17. The wireless speaker system as in claim 1, wherein said audio source generator is a video game.

18. The wireless speaker system as in claim 1, wherein said audio source generator is a home theater system.

19. The wireless speaker system as in claim 1, wherein said audio source generator is a public address system.

20. The wireless speaker system as in claim 1, wherein said audio source generator is a security system.

21. The wireless speaker system as in claim 1, wherein said transmitter includes RCA connectors and an audio input cord.

22. The wireless speaker system as in claim 1, wherein said transmitter includes inputs for two audio source generators.

23. The wireless speaker system as in claim 1, wherein said transmitter includes a wall-transformer power source.

24. A wireless speaker system for use with ceiling fans, comprising,
a ceiling fan including a ceiling fan housing member;
said ceiling fan housing member containing a wireless receiver and speakers;
an audio source generator for generating audio signals, distal from said ceiling fan housing member;
a transmitter for transmitting said audio signals to said wireless receiver;
an amplifier; and
a light source.

25. The wireless speaker system as in claim 24, wherein said light source is white LED lighting.

26. The wireless speaker system as in claim 24, wherein said system is multi-channel.

27. The wireless speaker system as in claim 24, wherein said system utilizes the existing power source already provided to said ceiling fan.

28. The wireless speaker system as in claim 24, wherein said ceiling fan housing member includes a power converter.

29. The wireless speaker system as in claim 24, wherein said ceiling fan housing member includes a remote control input.

30. The wireless speaker system as in claim 24, wherein said remote control input is operated by a remote control system.

31. The wireless speaker system as in claim 24, wherein said remote control system controls speaker system on/off, audio volume up/down, receiver channel and light on/off.

32. The wireless speaker system as in claim 24, wherein said ceiling fan housing member includes speakers.

33. The wireless speaker system as in claim 32, wherein said speakers include a bass speaker.

34. The wireless speaker system as in claim 32, wherein said speakers include a tweeter speaker.

35. The wireless speaker system as in claim 32, wherein said speakers include a mid-range speaker.

36. The wireless speaker system as in claim 24, wherein said audio source generator is a television.

37. The wireless speaker system as in claim 24, wherein said audio source generator is stereophonic.

38. The wireless speaker system as in claim 24, wherein said audio source generator is an amplifier.

39. The wireless speaker system as in claim 24, wherein said audio source generator is monophonic.

40. The wireless speaker system as in claim 24, wherein said audio source generator is a video game.

41. The wireless speaker system as in claim 24, wherein said audio source generator is a home theater system.

42. The wireless speaker system as in claim 24, wherein said audio source generator is a public address system.

43. The wireless speaker system as in claim 24, wherein said audio source generator is a security system.

44. The wireless speaker system as in claim 24, wherein said transmitter includes RCA connectors and an audio input cord.

45. The wireless speaker system as in claim 24, wherein said transmitter includes inputs for two audio sources.

46. The wireless speaker system as in claim 24, wherein said transmitter includes a wall-transformer power source.

47. A wireless speaker system for use with ceiling fans, said system comprising:
a ceiling fan including a ceiling fan housing member;
said ceiling fan housing member containing a wireless receiver;
said ceiling fan housing member including a bass speaker, a mid-range speaker and a tweeter speaker;
a power converter;
a remote control;
a remote control input;
an audio source generator for generating audio signals, distal from said ceiling fan housing member;
a transmitter for transmitting said audio signals to said wireless receiver; and
an amplifier.

48. A wireless speaker system for use with ceiling fans, said system comprising:
a ceiling fan including a ceiling fan housing member;
said ceiling fan housing member containing a wireless receiver;
said ceiling fan housing member including a bass speaker, a mid-range speaker and a tweeter speaker;
an audio amplifier;
a power converter;
a remote control;
a remote control input;
an audio source generator for generating audio signals, distal from said ceiling fan housing member;
a transmitter for transmitting said audio signals to said wireless receiver;
an amplifier; and
a light source.
